(19) United States
(12) Patent Application Publication
(10) Pub. No.: US 2018/0006512 A1
(43) Pub. Date: Jan. 4, 2018

(54) ARMATURE AND ROTATING ELECTRIC MACHINE

(71) Applicant: MITSUBISHI ELECTRIC CORPORATION, Chiyoda-ku, Tokyo (JP)

(72) Inventors: Hironori TSUIKI, Tokyo (JP); Koji KAWAMURA, Tokyo (JP); Takatoshi MASUDA, Tokyo (JP)

(73) Assignee: MITSUBISHI ELECTRIC CORPORATION, Chiyoda-ku, Tokyo (JP)

(21) Appl. No.: 15/541,976

(22) PCT Filed: Jan. 29, 2016
(86) PCT No.: PCT/JP2016/052656

§ 371 Date: Jul. 6, 2017

(30) Foreign Application Priority Data
Feb. 25, 2015 (JP) 2015-034757

(51) Int. Cl. H02K 1/18; H02K 3/34; H02K 1/16; H02K 3/487; H02K 3/52; H02K 15/02; H02K 3/14

(52) U.S. Cl. CPC H02K 1/18; H02K 3/487; H02K 3/345; H02K 3/522; H02K 1/16; H02K 3/14; H02K 15/026

(57) ABSTRACT

Provided are: a back yoke portion formed in an annular shape; a plurality of tooth portions arranged annularly on an inner periphery of the back yoke portion and forming a plurality of slots that are spaced apart in a circumferential direction and open on an outer peripheral side, the plurality of tooth portions being fitted to an inner peripheral surface of the back yoke portion; a coil housed in the plurality of slots; and a wedge disposed between the coil and the back yoke portion, at an opening of each of the plurality of slots.

### TECHNICAL FIELD

The present invention relates to an armature and a rotating electric machine that are capable of preventing damage of a coil.

### BACKGROUND ART

In recent years, for rotating electric machines such as electric motors or generators, there has been a demand for a low-vibration, high-power rotating electric machine. One approach for providing a low-vibration, high-power motor is increasing the length of a collar portion provided at each tooth end of a core to reduce the width of the opening of a slot of an armature. A reduction in the width of the opening of the slot results in: a reduction in the saliency of the armature, which leads to a reduction in vibration; and also an increase in the surface area on which magnetic flux is generated, thus allowing for an equivalent reduction in the gap between the armature and a rotor, which increases power output. The width of the opening of the slot, however, is required to be at least two times the wire diameter of a coil because a winding needs to be inserted into the slot.

In response, Patent Documents 1, 2, and 3 propose rotating electric machines, each of which: uses an inner-outer-split core in which collar portions at each tooth end of the core are connected to each other and tooth portions and a back yoke portion are separate; and is configured such that a coil is inserted thereinto from the radially outer side. Such a configuration can eliminate openings to reduce vibration.

When collar portions are partially joined as in Patent Document 4, the leakage of magnetic flux from a stator is reduced, and thus a higher-power motor can be provided.

### CITATION LIST

### Patent Document

Patent Document 1: Japanese Laid-Open Patent Publication No. 2009-033925

Patent Document 2: Japanese Laid-Open Patent Publication No. 2007-288848

Patent Document 3: Japanese Laid-open Patent Publication No. 2009-077534

Patent Document 4: Japanese Laid-Open Patent Publication (translation of PCT application) No. 2002-526019

### SUMMARY OF THE INVENTION

### Problems to be Solved by the Invention

In existing armatures and rotating electric machines, a sheet-shaped insulating material is used to provide insulation between the coil and the core, and therefore, when an outer core formed by stacking punching materials is inserted, the edge of the outer core may contact the sheet-shaped insulating material to bend or tear the sheet-shaped insulating material, which may lead to damage of the coil. When there is no insulating material, the coil is exposed, and therefore there is the problem that the coil may be damaged when the outer core is inserted.

The present invention has been made to solve the above problem, and an object of the present invention is to provide an armature and a rotating electric machine that prevent damage of a coil.

### Solution to the Problems

An armature according to the present invention includes:

a back yoke portion formed in an annular shape;

a plurality of tooth portions arranged annularly on an inner periphery of the back yoke portion and forming a plurality of slots that are spaced apart in a circumferential direction and open on an outer peripheral side, the plurality of tooth portions being fitted to an inner peripheral surface of the back yoke portion;

a coil housed in the plurality of slots; and

a wedge disposed between the coil and the back yoke portion, on an opening side of each of the plurality of slots.

A rotating electric machine according to the present invention includes: the armature described above; and a rotor disposed in the annular shape of the armature.

### Effect of the Invention

With the armature and the rotating electric machine according to the present invention, it is possible to prevent damage of the coil.

### BRIEF DESCRIPTION OF THE DRAWINGS

FIG. 1 is a perspective view showing the configuration of an armature according to Embodiment 1 of the present invention.

FIG. 2 is a plan cross-sectional view showing the configuration of the armature shown in FIG. 1.

FIG. 3 is a perspective view showing the configuration of a back yoke portion of the armature shown in FIG. 1.

FIG. 4 is a perspective view showing the configuration of tooth portions of the armature shown in FIG. 1.

FIG. 5 is a perspective view showing the configuration of a wedge of the armature shown in FIG. 1.

FIGS. 6A and 6B are perspective views for describing a method for manufacturing the armature shown in FIG. 1.

FIG. 7 is a perspective view for describing the method for manufacturing the armature shown in FIG. 1.

FIG. 8 is a perspective view for describing the method for manufacturing the armature shown in FIG. 1.

FIG. 9 is a side cross-sectional view for describing the method for manufacturing the armature shown in FIG. 1.

FIG. 10 is a side cross-sectional view for describing the method for manufacturing the armature shown in FIG. 1.

FIG. 11 is a side view showing the configuration of a rotating electric machine using the armature shown in FIG. 1.

FIGS. 12A and 12B are perspective views showing a method for manufacturing another armature according to Embodiment 1 of the present invention.

FIG. 13 is a perspective view for describing the method for manufacturing the armature shown in FIG. 12.

FIG. 14 is a perspective view showing a method for manufacturing another armature according to Embodiment 1 of the present invention.

FIG. 15 is a perspective view showing the configuration of an armature according to Embodiment 2 of the present invention.

FIG. 16 is a partial plan cross-sectional view showing the configuration of the armature shown in FIG. 15.

FIG. 17 is a perspective view showing the configuration of tooth portions of the armature shown in FIG. 15.

FIG. 18 is a plan view showing the configuration of the tooth portions shown in FIG. 17.

FIG. 19 is a perspective view showing the configuration of a back yoke portion of the armature shown in FIG. 15.

FIGS. 20A and 20B are perspective views for describing a method for manufacturing the armature shown in FIG. 15.

FIG. 21 is a perspective view for describing the method for manufacturing the armature, shown in FIG. 15.

FIG. 22 is a perspective view for describing the method for manufacturing the armature shown in FIG. 15.

FIG. 23 is a plan cross-sectional view stowing the configuration of another armature according to Embodiment 2 of the present invention.

FIG. 24 is a plan cross-sectional view showing the configuration of another armature according to Embodiment 2 of the present invention.

FIG. 25 is a perspective view showing the configuration of an armature according to Embodiment 3 of the present invention.

FIG. 26 is a plan cross-sectional view showing the configuration of the armature shown in FIG. 25.

FIG. 27 is a perspective view showing the configuration of a back yoke portion of the armature shown in FIG. 25.

FIG. 28 is a perspective view snowing the configuration of tooth portions of the armature shown in FIG. 25.

FIG. 29 is a perspective view showing the configuration of a coil of the armature shown in FIG. 25.

FIG. 30 is a perspective view showing the configuration of insulating sheets and bobbins of the armature shown in FIG. 25.

FIG. 31 is a perspective view for describing a method for manufacturing the armature shown in FIG. 25.

FIG. 32 is a perspective view for describing the method for manufacturing the armature shown in FIG. 25.

FIG. 33 is a perspective view for describing the method for manufacturing the armature shown in FIG. 25.

### DESCRIPTION OF EMBODIMENTS

### Embodiment 1

Hereinafter, embodiments of the present invention will be described.

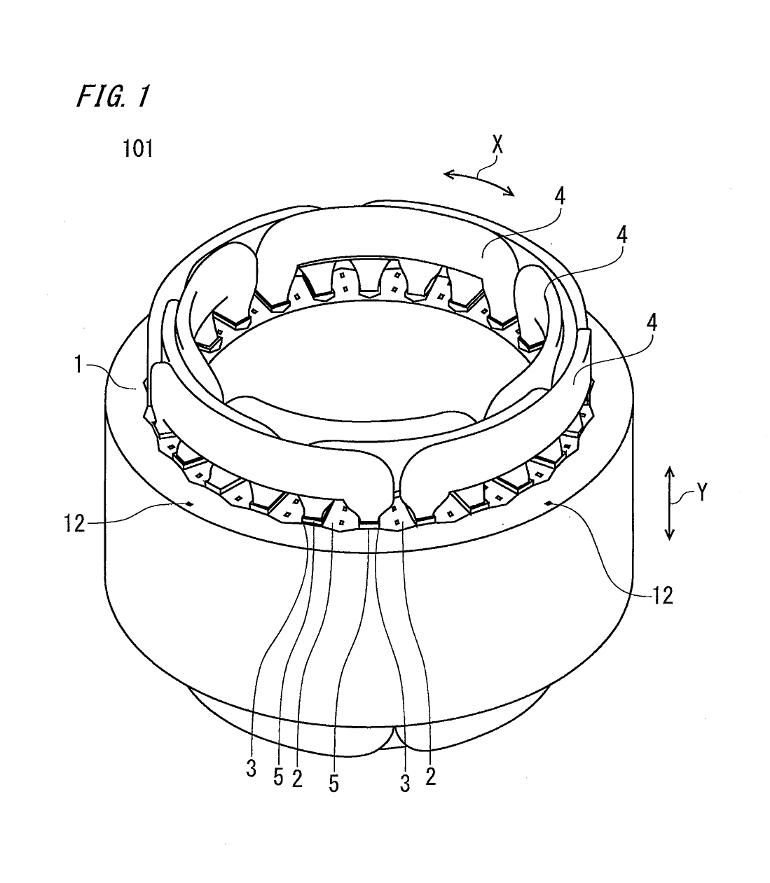

FIG. 1 is a perspective view showing the configuration of an armature according to Embodiment 1 of the present invention.

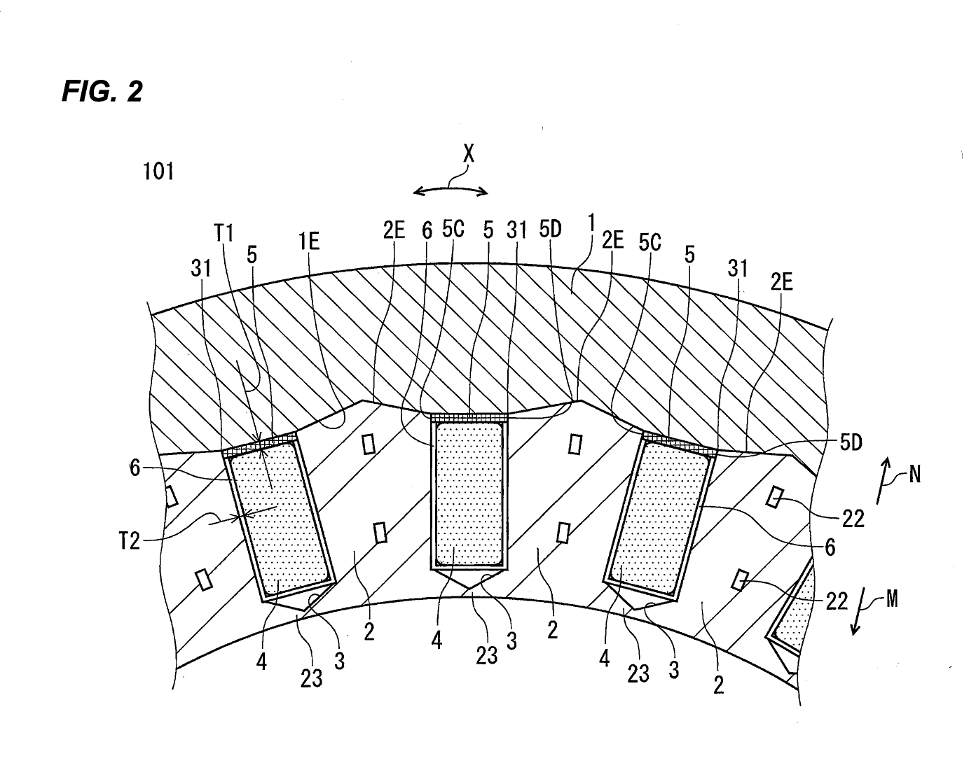

FIG. 2 is a partial plan cross-sectional view showing a cross-section taken on a plane through a part of the configuration of the armature shown in FIG. 1.

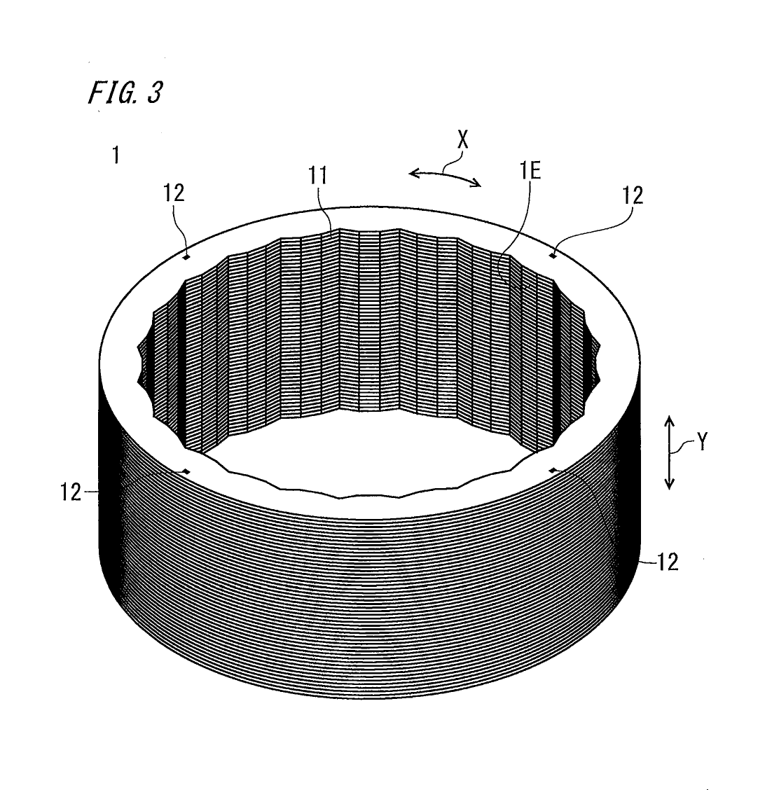

FIG. 3 is a perspective view showing the configuration of a back yoke portion of the armature shown in FIG. 1.

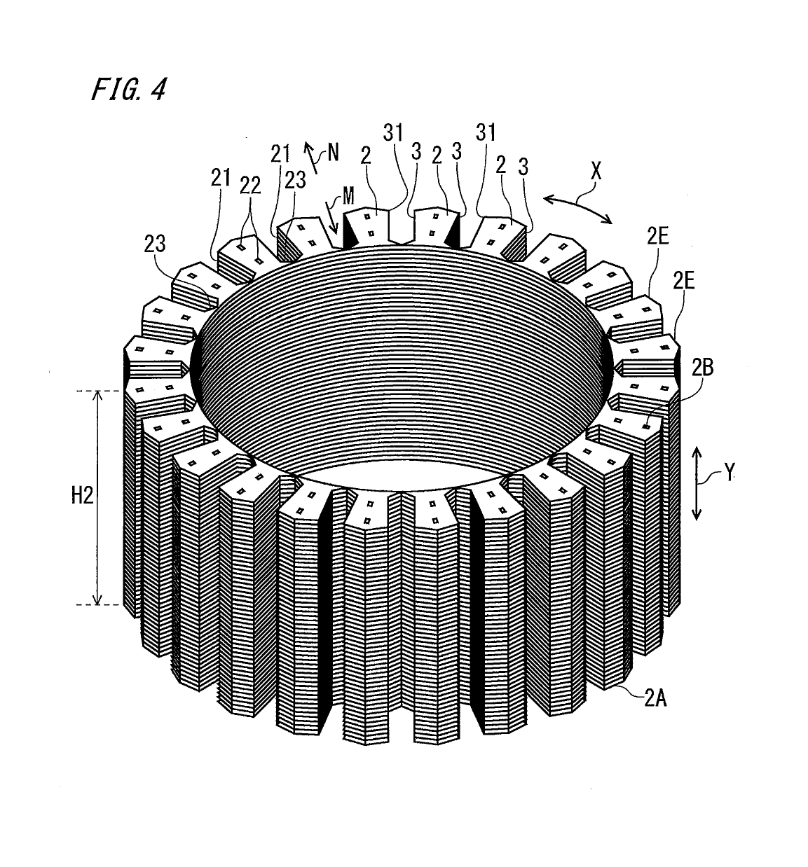

FIG. 4 is a perspective view showing the configuration of tooth portions of the armature shown in FIG. 1.

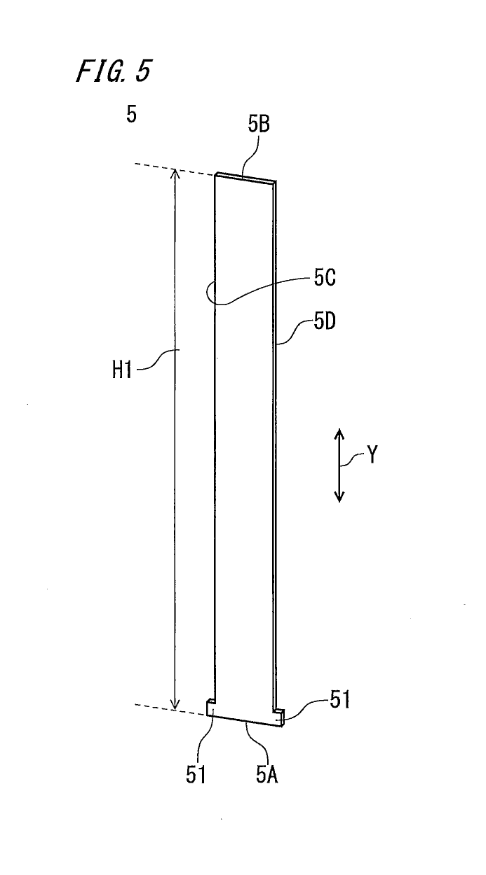

FIG. 5 is a perspective view showing the configuration of a wedge of the armature shown in FIG. 1.

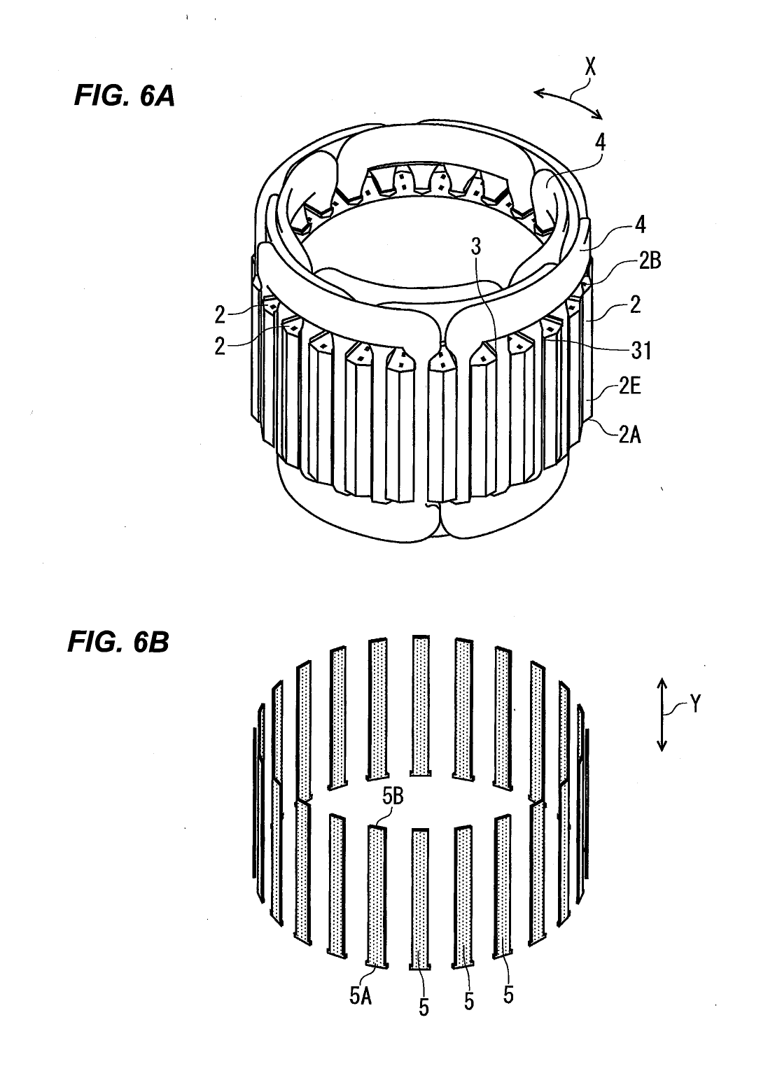

FIG. 6 to FIG. 12 are diagrams for describing a method for manufacturing the armature shown in FIG. 1.

FIG. 6 is a perspective view showing a state before wedges are inserted to the tooth portions.

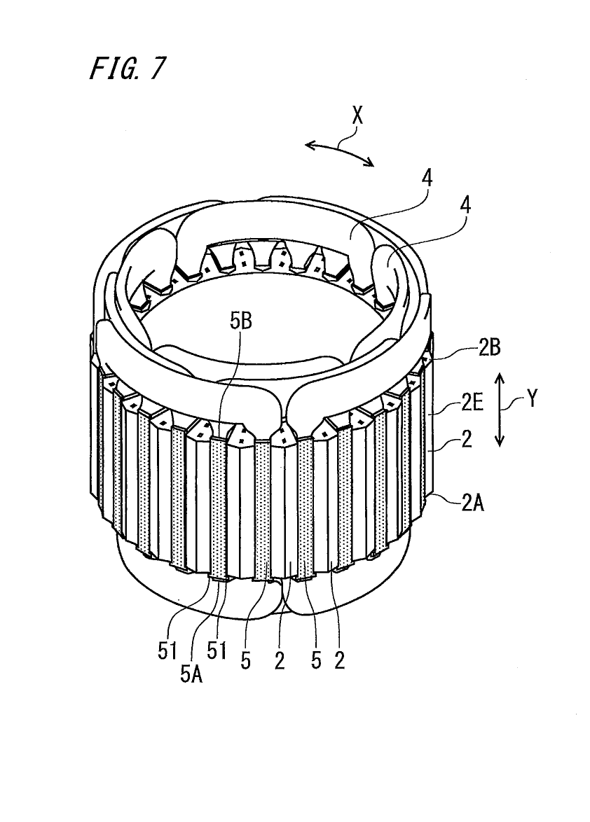

FIG. 7 is a perspective view showing a state after the wedges are inserted to the tooth portions.

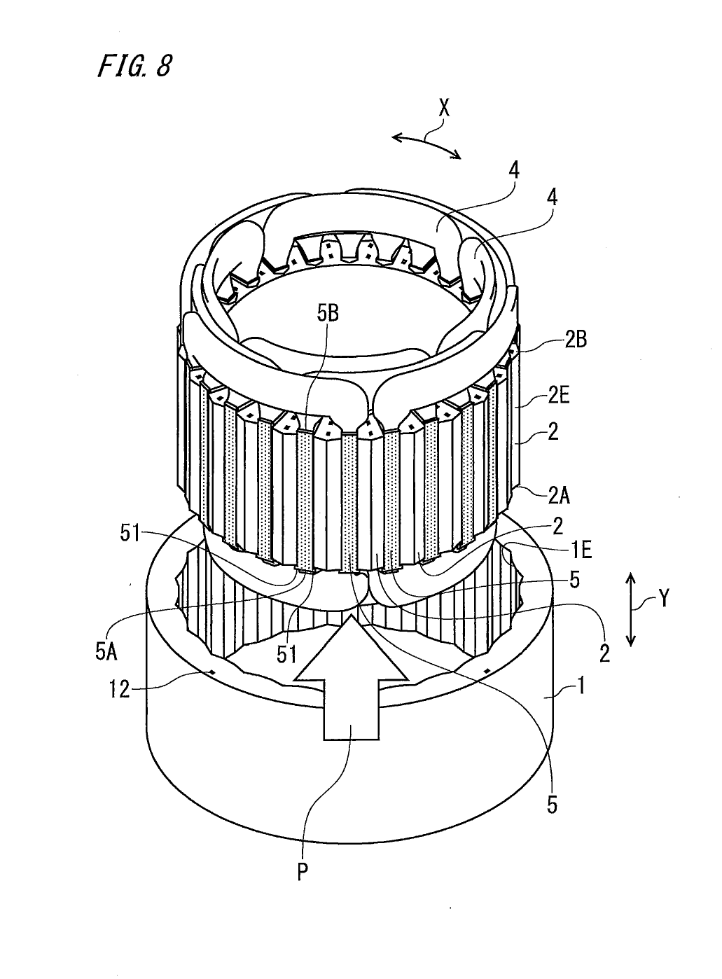

FIG. 8 is a perspective view showing a state before the back yoke portion is inserted to the tooth portions.

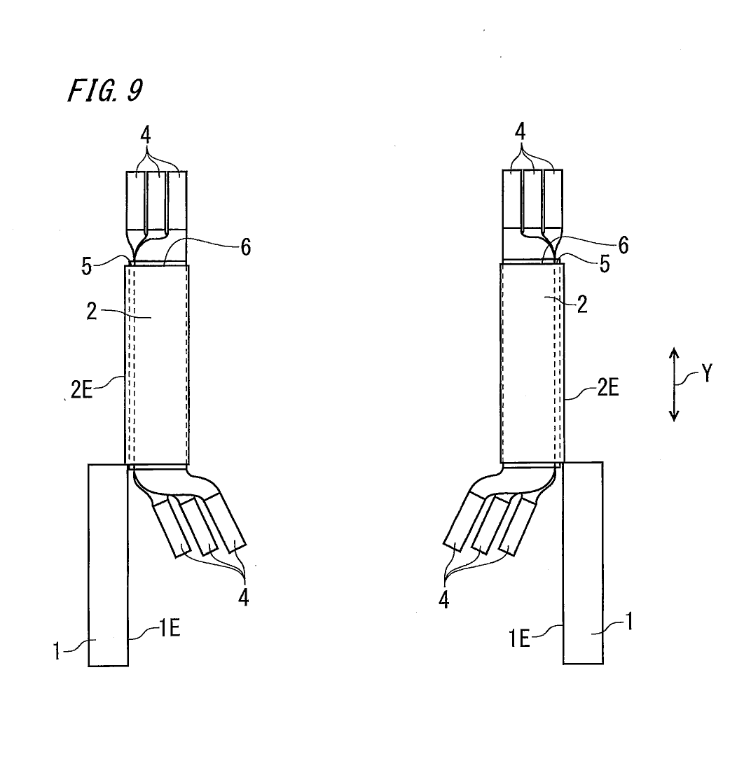

FIG. 9 is a side cross-sectional view showing side surfaces of parts in a state before the back yoke portion is inserted to the tooth portions.

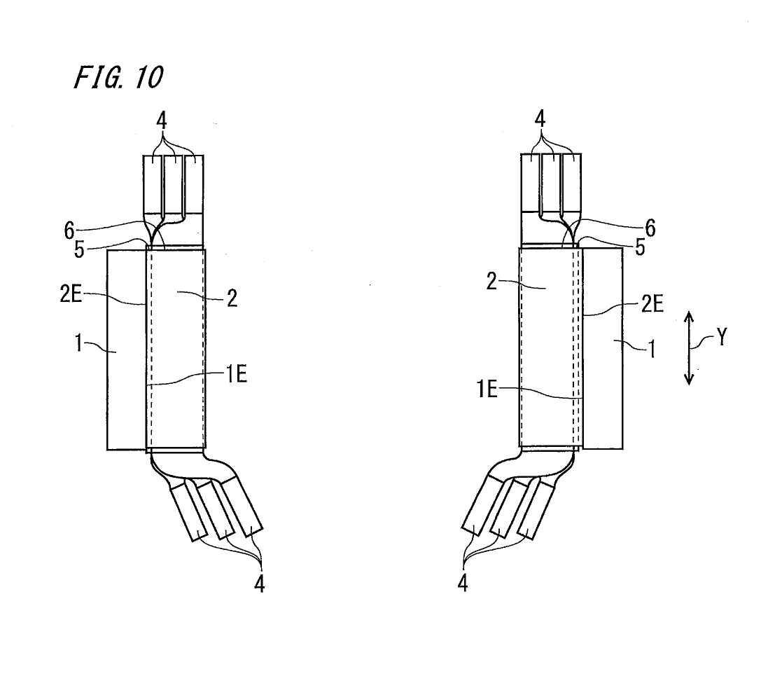

FIG. 10 is a side cross-sectional view showing side surfaces of parts in a state after the back yoke portion is inserted to the tooth portions.

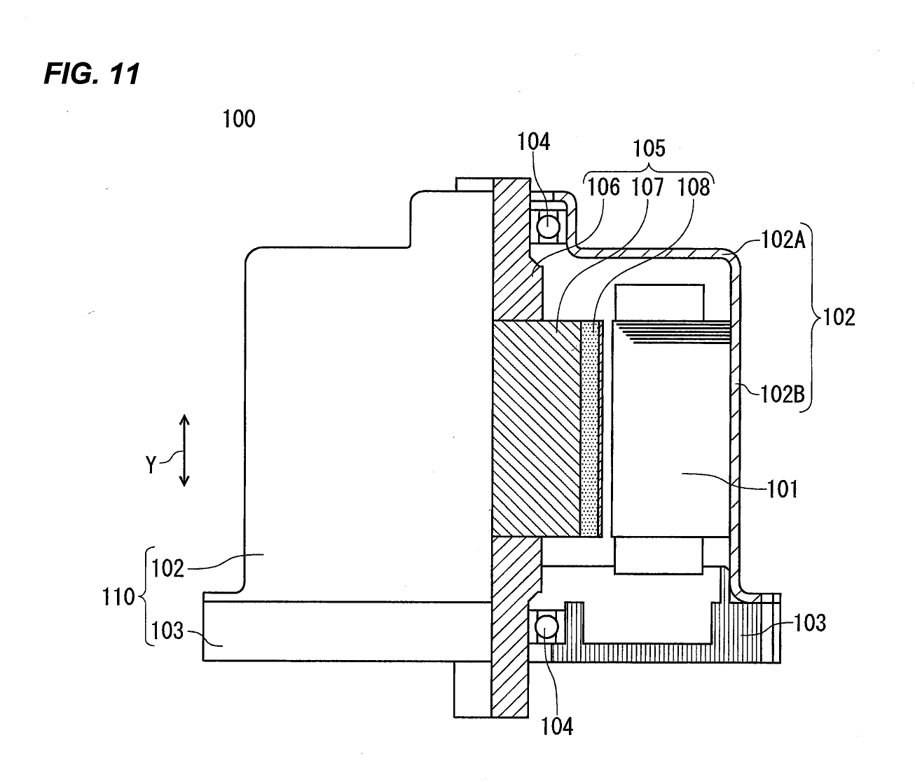

FIG. 11 is a side view showing the configuration of a rotating electric machine using the armature shown in FIG. 1.

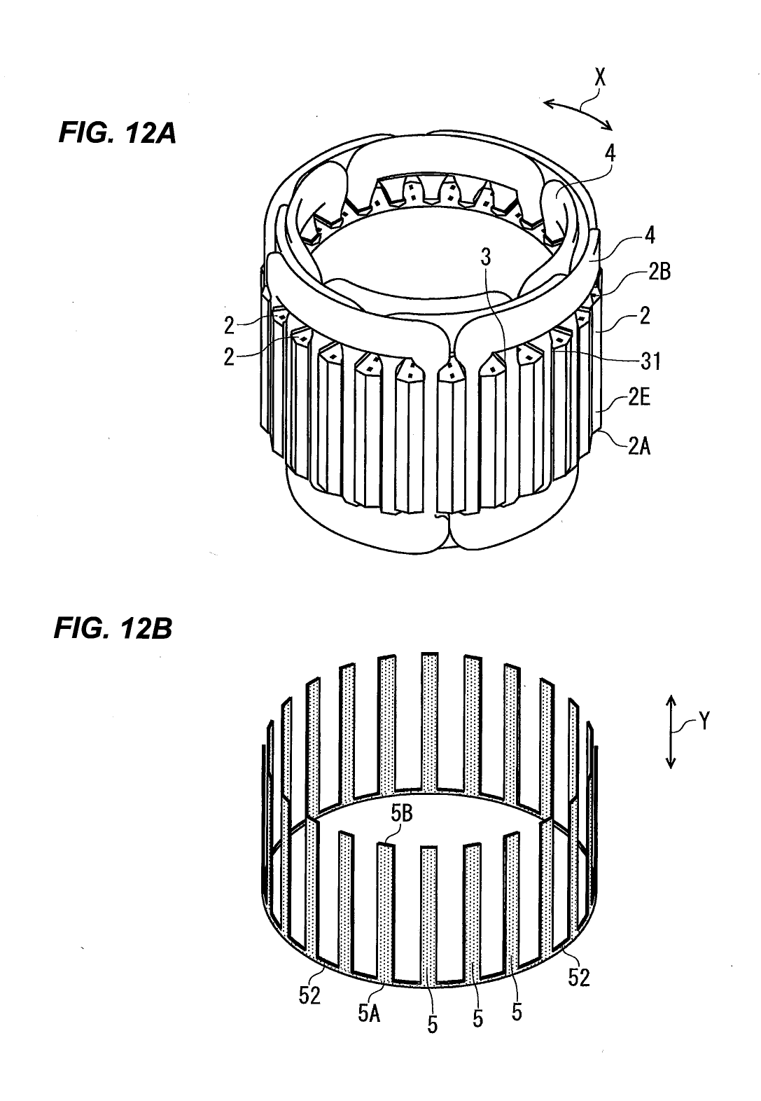

FIG. 12 to FIG. 14 are perspective views showing a method for manufacturing another armature according to Embodiment 1 of the present invention.

In FIG. 1, an armature 101 formed in an annular shape includes: a back yoke portion 1; a plurality of tooth portions 2 for forming magnetic poles; coils 4 housed in a plurality of slots 3; and wedges 5 that protect the coils 4. Each coil 4 is formed by winding an insolation-coated conductor wire a plurality of times so as to extend across two different slots 3.

In FIG. 3, the back yoke portion 1 is formed by stacking a plurality of magnetic steel plates 11 each of which is formed in an annular shape. A plurality of crimp portions 12 are formed on the back yoke portion 1 and at different positions in a circumferential direction X. The plurality of steel plates 11 are fixed in a stacking direction, that is, in an axial direction Y, by crimping the crimp portions 12. An inner peripheral surface 1E of the back yoke portion 1 is formed so that later-described protruding surfaces 2E of the tooth portions 2 are fitted to the inner peripheral surface 1E.

In FIG. 4, the plurality of tooth portions 2 are formed so as to be arranged annularly. Each of the tooth portions 2 is formed by stacking a plurality of magnetic steel plates 21 as with the back yoke portion 1. Crimp portions 22 are formed on each of the tooth portions 2, and the plurality of steel plates 21 are crimped and fixed at the crimp portion 22 in the axial direction Y. The plurality of tooth portions 2 are formed so as to be connected to each other at connecting portions 23 in the circumferential direction X on a central side M. Thus, the plurality of tooth portions 2 are held annularly as shown in FIG. 4. A slot 3 that is open on an outer peripheral side N to form an opening 31 is formed between each pair of the plurality of tooth portions 2 in the circumferential direction X.

In FIG. 5, the wedge 5 is formed of a plate-like member. For example, when the plate-like member is formed of an insulating member such as glass epoxy, it is conceivable to form the plate-like member by mixing magnetic metal powder and resin such as nylon and shaping and curing the mixture into a magnetic member. A length H1 of the wedge 5 in the axial direction Y is set to be greater than a length H2 of the tooth portion 2 in the axial direction Y. Protrusion 51 protruding in the circumferential direction X on both sides 5C and 5D of the wedge 5 are formed on one end 5A of the wedge 5 in the axial direction Y. The protrusion 51 abuts one end 2A of the tooth portion 2 in the axial direction Y when the armature 101 is assembled.

In FIG. 2, an insulating sheet 6 having a substantially U shape is disposed between each coil 4 and each tooth portion 2. The insulating sheet 6 is, for example, formed of an insulating material such as polyphenylene sulfide or polyethylene terephthalate. The wedge 5 is arranged on the opening 31 side of each of the plurality of slots 3 and disposed between the coil 4 and the back yoke portion 1 with both sides 5C and 5D held in the opening 31 of the slot 3. The inner peripheral surface 1E of the back yoke portion 1 and the protruding surface 2E of each tooth portion 2 on the outer peripheral side N are fitted together in abutment. Accordingly, the back yoke portion 1 and each tooth portion 2 are not only mechanically connected, but also magnetically connected.

A thickness T1 of the wedge 5 is set to be greater than a thickness T2 of the insulating sheet 6. The insulating sheet 6 is formed inside the slot 3. Therefore, the thickness 12 of the insulating sheet 6 needs to be set to be as small as possible in order to provide a sufficient effective area for the coil 4. When the thickness T1 of the wedge 5 is set to be greater than the thickness T2 of the insulating sheet 5, the wedge 5 prevents damage of the coils 4 and the insulating sheet 6 due to external factors. The relationship between the thickness T1 of the wedge 5 and the thickness T2 of the insulating sheet 6 applies to the embodiments described below, and therefore the description thereof is omitted as appropriate.

In FIG. 11, a rotating electric machine 100 includes the armature 101 and a rotor 105 disposed in the annular shape of the armature 101. The rotating electric machine 100 is housed in a housing 110 including: a frame 102 having a cylindrical portion 1023 and a bottom portion 102A for closing one end of the frame 102; and an end plate 103 for covering an opening of the frame 102 on the opposite end. The armature 101 is fixed within the cylindrical portion 102B of the frame 102 in a fitting manner.

The rotor 105 is rotatably disposed on the inner peripheral side of the armature 101 so as to be fixed to a rotating shaft 106 which is rotatably supported by each of the bottom portion 102A of the frame 102 and the end plate 103 via a bearing 104. The rotor 105 is formed as a permanent magnet type including: a rotor core 107 fixed to the rotating shaft 106; and a plurality of permanent magnets 108 aligned at a predetermined interval in the circumferential direction and embedded in the rotor core 107, on the outer peripheral surface aide thereof, to form magnetic poles.

Next, a description will be given of a method or manufacturing the armature 101 of the rotating electric machine 100 according to Embodiment 1 configured as described above. First, as shown in FIG. 6(A), each coil 4 is wound and housed in the slots 3 between the plurality of tooth portions 2, which are arranged annularly, with the insulating sheets 6 interposed therebetween. Subsequently, as shown in FIG. 6(B), each wedge 5 is disposed so that the one end 5A of the wedge 5 is on the bottom side in the axial direction Y, in order to be inserted into the opening 31 of each slot 3 from an opposite end 5B of the wedge 5 in the axial direction Y.

When the wedges 5 are inserted to the opening 31 sides of the respective slots 3, each wedge 3 is disposed on the opening 31 side of the slot 3, as shown in FIG. 7. The protrusion 51 of the wedge 5 at the one end 5A abuts the one end 2A of the tooth portion 2. The wedge 5 is then positioned by the protrusion 51. Since the length H1 of the wedge 5 is set to be greater than the length H2 of the tooth portion 2, the opposite end 5B of the wedge 5 is exposed on the opposite end 2B of the tooth portion 2.

Although each wedge 5 is inserted from below the slot 3 in the axial direction Y in the above example, the insertion is not limited to the above example; it is conceivable that each wedge 5 may be inserted from above the slot 3 in the axial direction Y. In this case, the one end 5A of the wedge 5 is disposed on the upper side in the axial direction Y, and the protrusion 51 of the wedge 5 abuts the opposite end 2B of the tooth portion 2 so that the wedge 5 is positioned. The same applies to the embodiments described below, and therefore the description thereof is omitted as appropriate.

Next, as shown in FIG. 8 and FIG. 9, the back yoke portion 1 is inserted from the one ends 2A of the tooth portions 2 in the direction of an arrow P. Subsequently, as shown in FIG. 1 and FIG. 10, the protruding surface 2E of each tooth portion 2 is fitted to the inner peripheral surface 1E of the back yoke portion 1 in abutment therewith, to form the armature 101. At this time, the wedges 5 are located between the coils 4 and the back yoke portion 1, and therefore damage of the coils 4 due to the back yoke portion 1 is prevented. Furthermore, the wedges 5 prevent the insulating sheets 6 from being exposed in the openings 31 of the slots 3, and therefore damage of the inner peripheral surface 1E of the back yoke portion 1 due to the insulating sheets 6 is prevented.

Although Embodiment 1 has described the example in which each of the plurality of wedges 5 is separately formed, the wedges 5 are not limited to this example; for example, as shown in FIG. 12(B), the plurality of wedges 5 may be connected to each other by connecting portions 52 at the one end 5A of each wedge 5 in the axial direction Y. FIG. 12(A) shows the same state as in FIG. 6(A) described above in Embodiment 1.

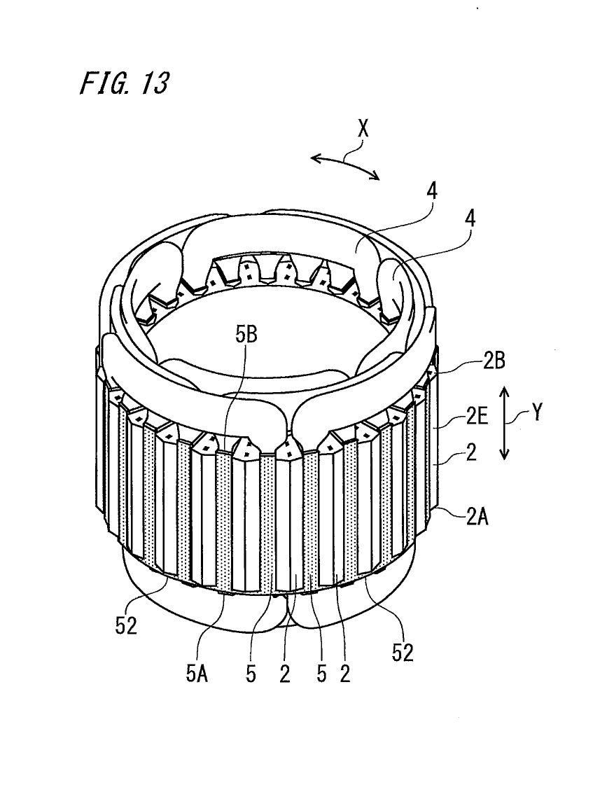

The wedges 5 including the connecting portions 52 shown in FIG. 12(B) are then disposed by being inserted to the opening 31 sides of the slots 3, as shown in FIG. 13. Thus, the connecting portions 32 function similarly to the protrusions 51 described above in Embodiment 1 and abut the one ends 2A of the tooth portions 2 in the axial direction Y, and thus can achieve the same advantageous effects as the protrusions 51. Furthermore, since the wedges 5 are connected to each other by the connecting portions 52, it is possible to reduce the number of the components. In addition, the wedges 5 can be easily disposed in the slots 3.

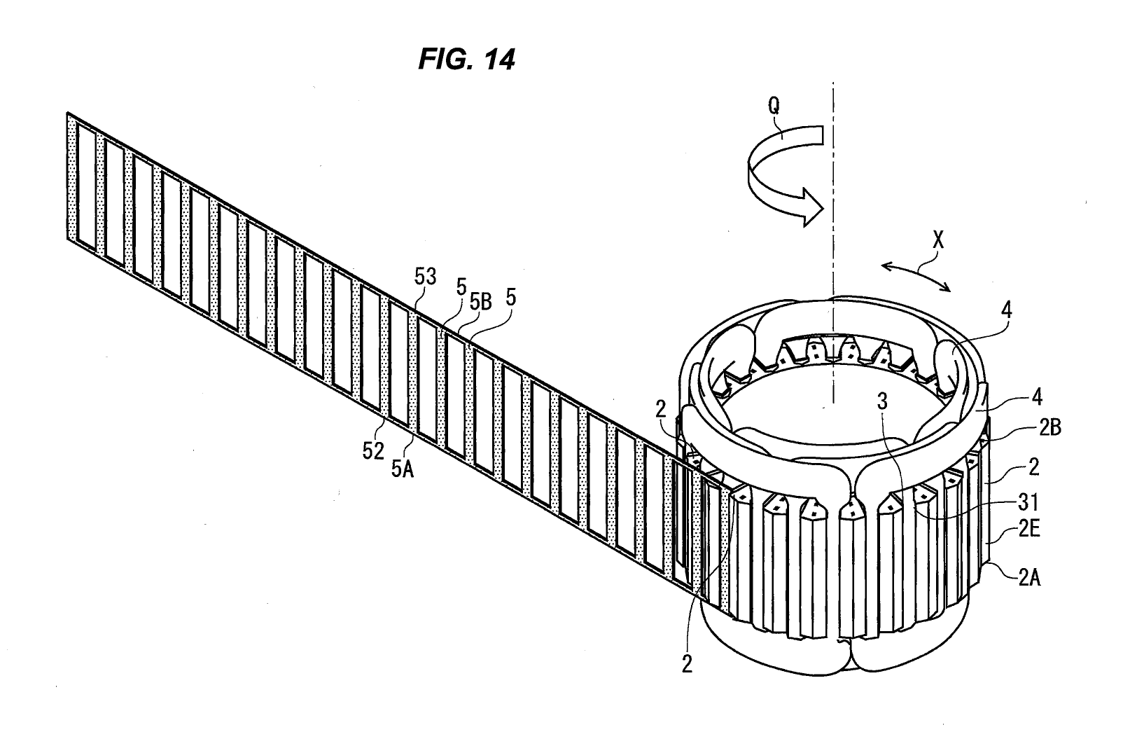

As another example, connecting portions 52 and 53 connecting the one ends 5A and the opposite ends 5B of the plurality of wedges 5 in the axial direction Y, respectively, are included as shown in FIG. 14, for example. In order to dispose the wedges 5 including the connecting portions 52 and 53 shown in FIG. 14 on the opening 31 sides of the slots 3, the tooth portions 2, which are arranged annularly, are rotated in the direction of an arrow Q so that the wedges 5 are wound around the tooth portions 2. Thus, since the wedges 5 are connected to each other by the connecting portions 52 and 53, it is possible to not only reduce the number of the components, but also more easily dispose the wedges 5 in the slots 3.

In the armature and the rotating electric machine according to Embodiment 1 configured as described above, since the wedges are provided at positions between the coils and the back yoke portion, when the back yoke portion is press-fitted, damage of the coils and the insulating sheets can be prevented and thus dielectric breakdown can be prevented, so that it is possible to provide a high-quality armature and a high-quality rotating electric machine.

Furthermore, since the thickness of each wedge is set to be greater than the thickness of each insulating sheet, damage of the coils and the insulating sheets can be more effectively prevented when the back yoke portion is press-fitted.

Furthermore, since the length of each wedge in the axial direction is set to be greater than the length of each tooth portion in the axial direction, one end of each wedge in the axial direction protrudes from the tooth portion when the wedge is fitted to the tooth portion. Therefore, upon insertion of the back yoke portion, this protruding portion serves as a guide to facilitate the insertion of the back yoke portion, which improves the productivity.

Furthermore, each wedge has, on one end thereof in the axial direction, abutting protrusions in the circumferential direction, and the protrusions abut the one ends of the tooth portions in the axial direction. Therefore, when each wedge is fitted into the slot between the tooth portions, the protrusions serve as a guide for positioning the wedge, so that the wedge can be prevented from being displaced, which improves the productivity.

Furthermore, when each wedge is formed of an insulating member, increased breakdown voltage characteristics are obtained. Furthermore, when each wedge is formed of a magnetic member, the wedge can be used as a magnetic path, and thus it is possible to inhibit magnetic saturation. p Although Embodiment 1 has described the example in which the rotor is formed as a permanent magnet type, the rotor is not limited to this example, and may be formed as a squirrel-cage rotor or a wound rotor. The same applies to the embodiments described below, and therefore the description thereof is omitted as appropriate.

### Embodiment 2

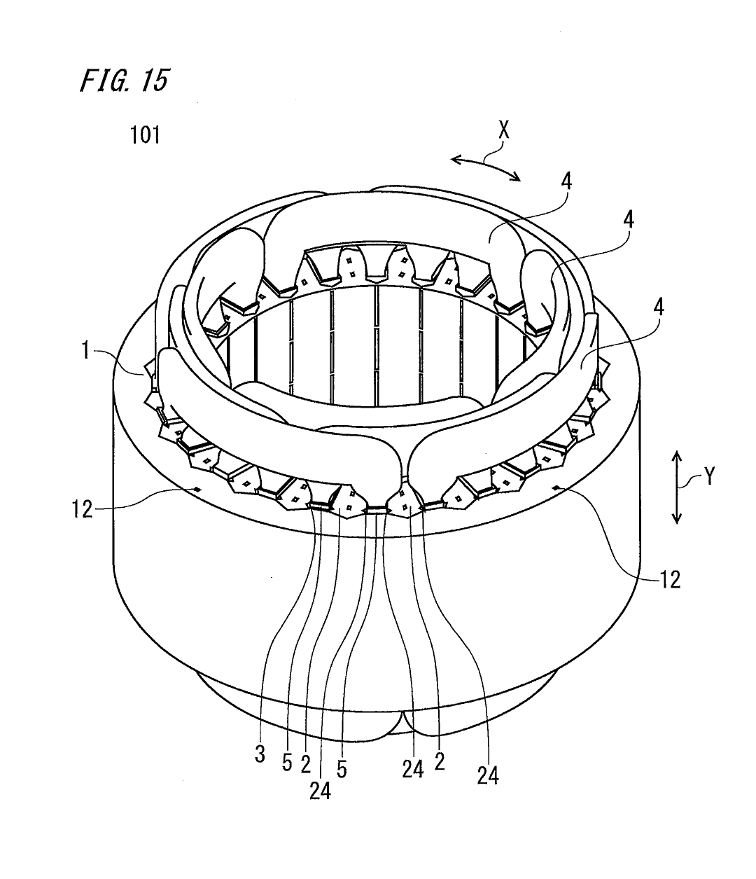

FIG. 15 is a perspective view showing the configuration of an armature according to Embodiment 2 of the present invention.

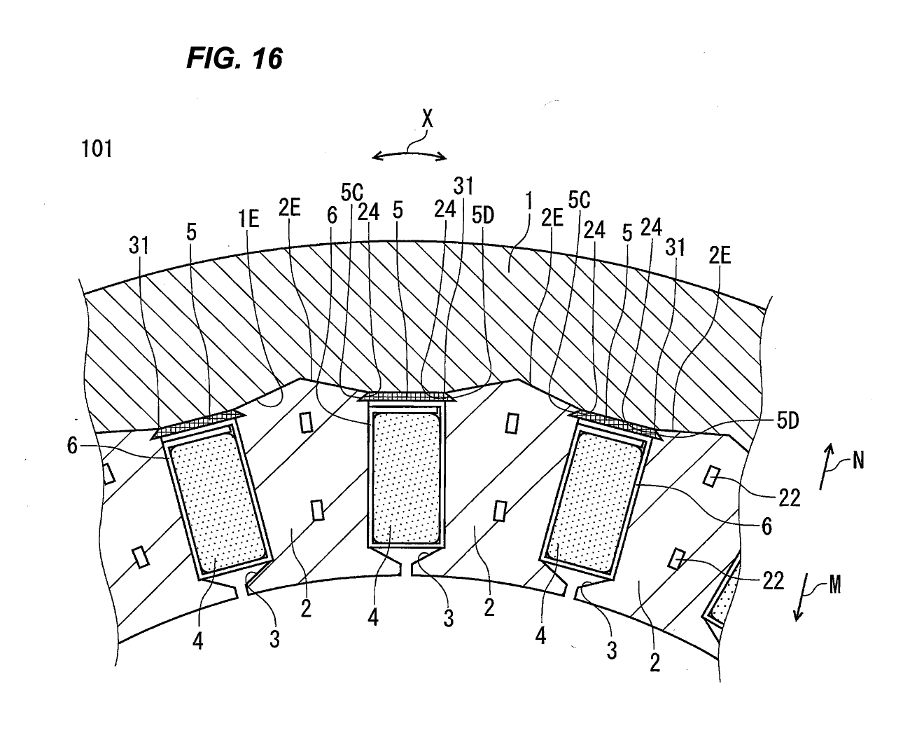

FIG. 16 is a partial plan cross-sectional view showing the configuration of the armature shown in FIG. 15.

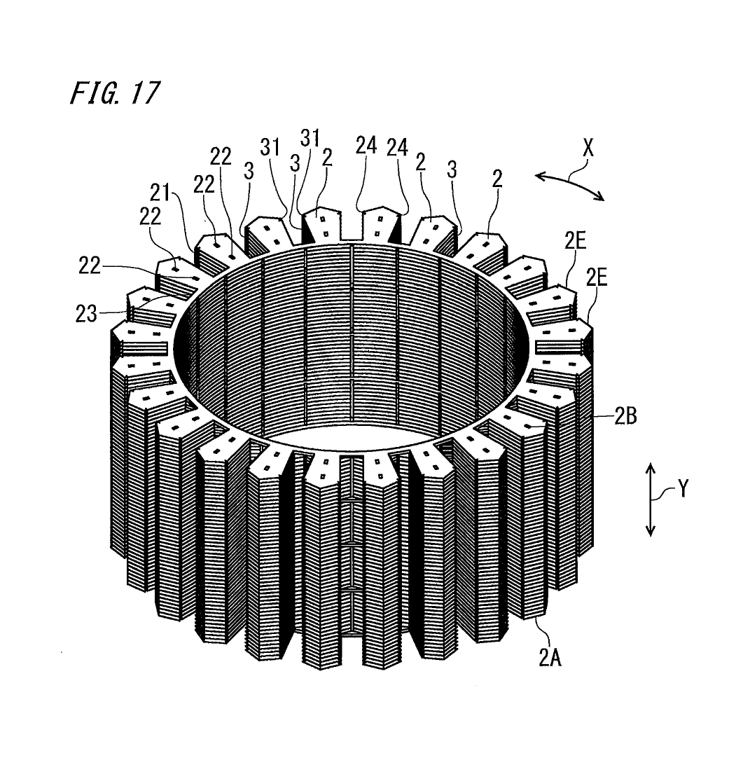

FIG. 17 is a perspective view showing the configuration of tooth portions of the armature shown in FIG. 15.

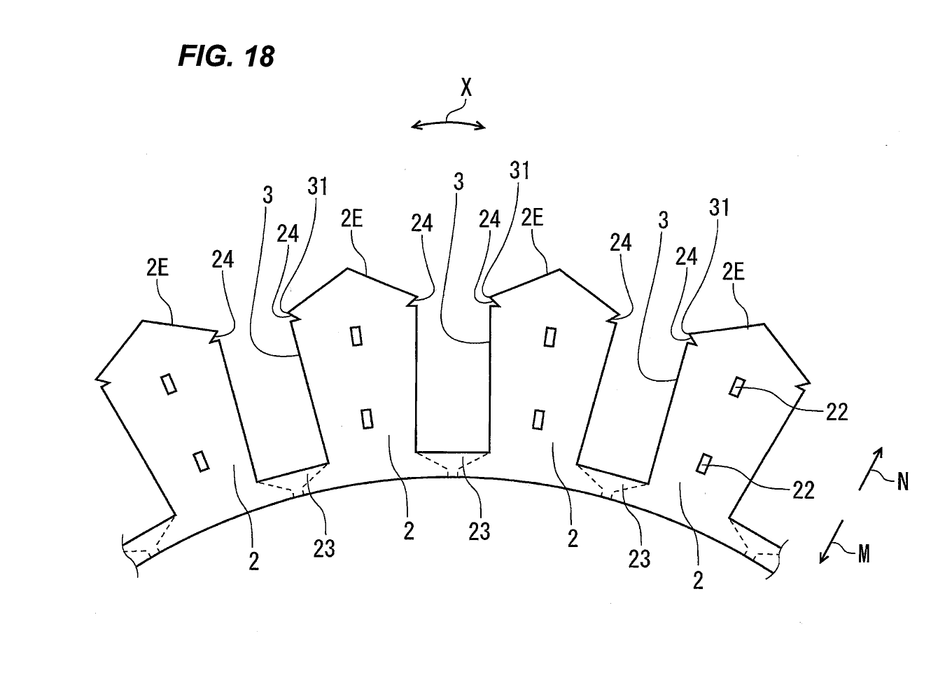

FIG. 18 is a plan view showing the configuration of the tooth portions shown in FIG. 17.

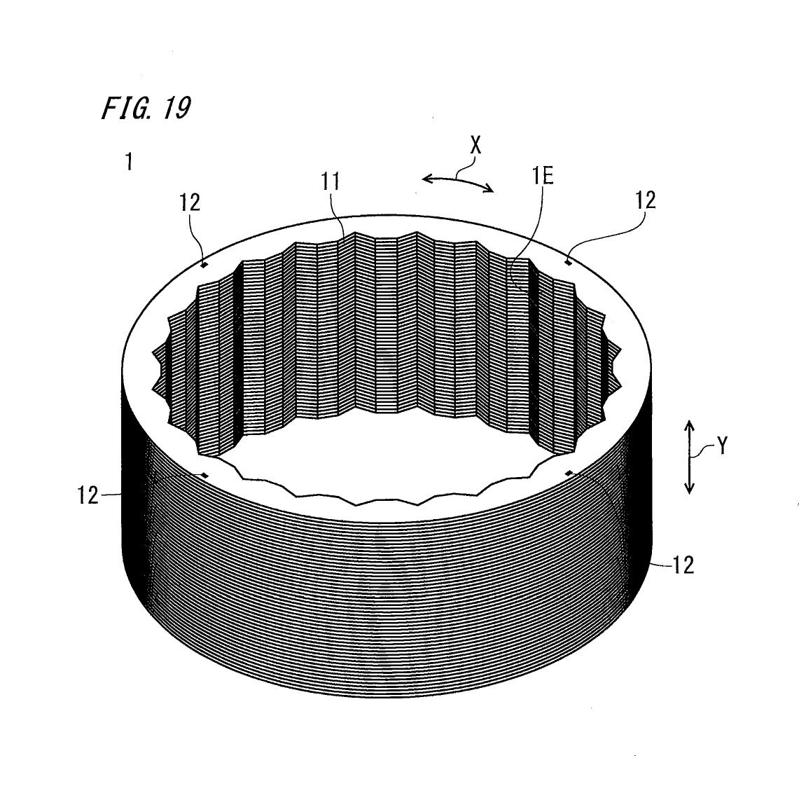

FIG. 19 is a perspective view showing the configuration of a back yoke portion of the armature shown in FIG. 15.

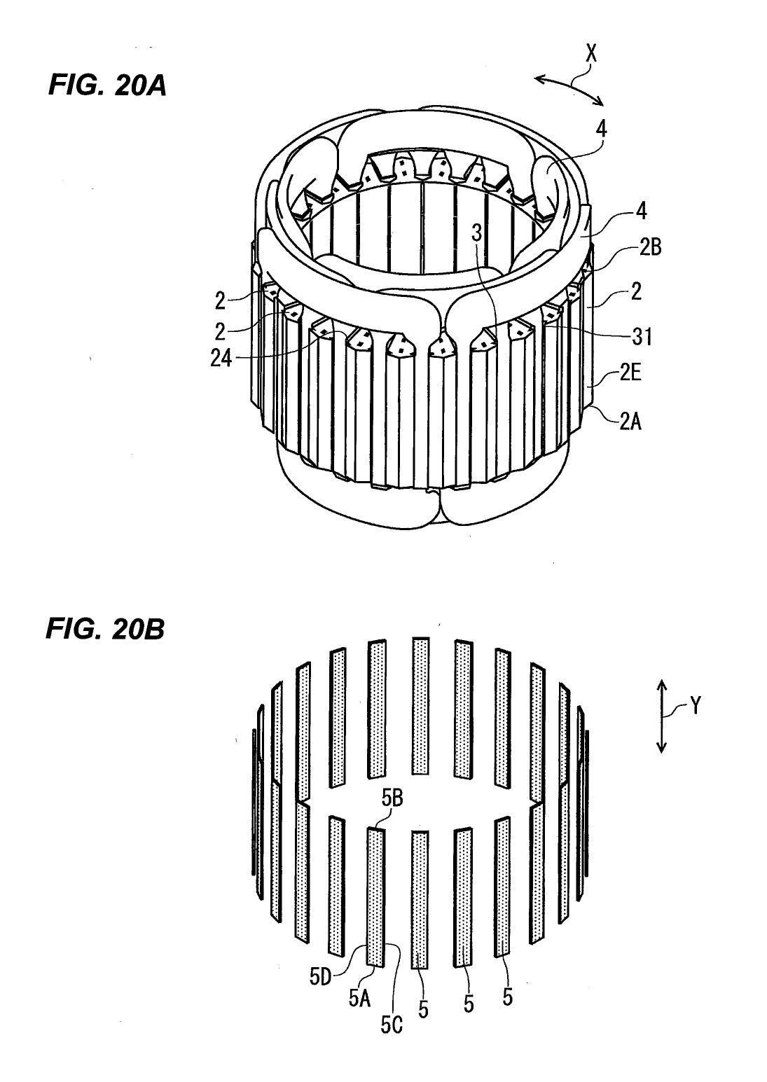

FIG. 20 is a perspective view for describing a method for manufacturing the armature shown in FIG. 15.

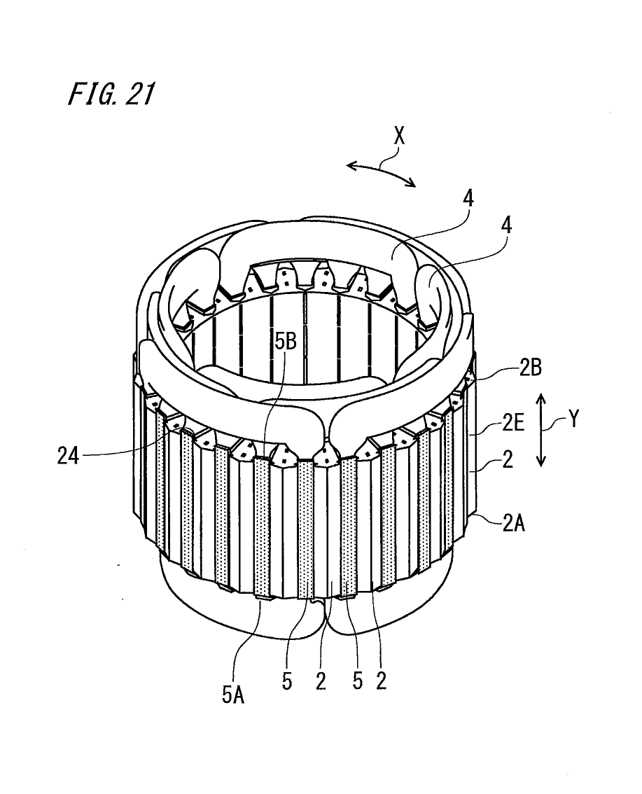

FIG. 21 is a perspective view for describing the method for manufacturing the armature shown in FIG. 15.

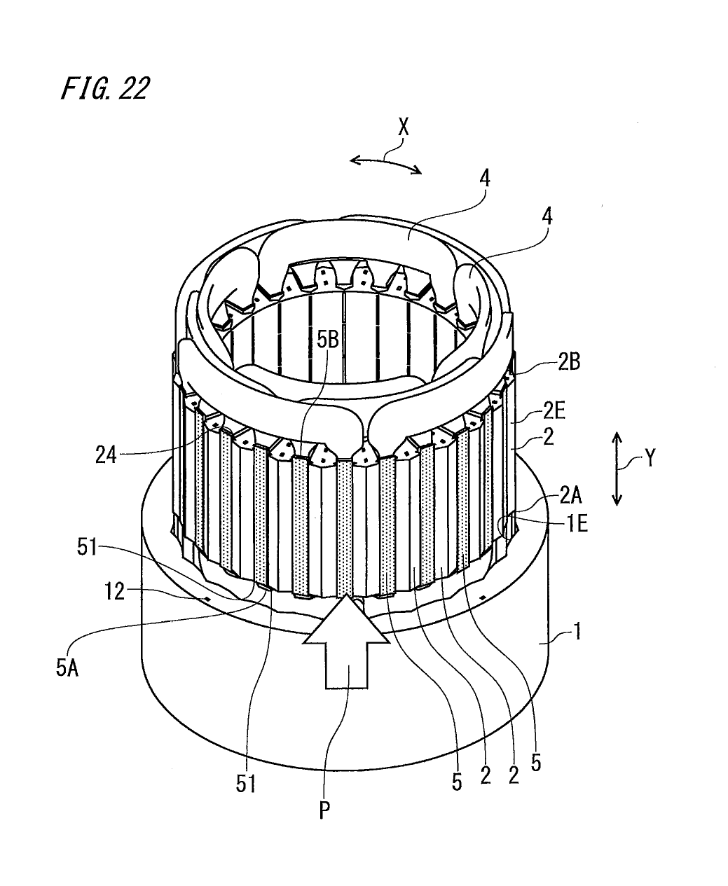

FIG. 22 is a perspective view for describing the method for manufacturing the armature shown in FIG. 15.

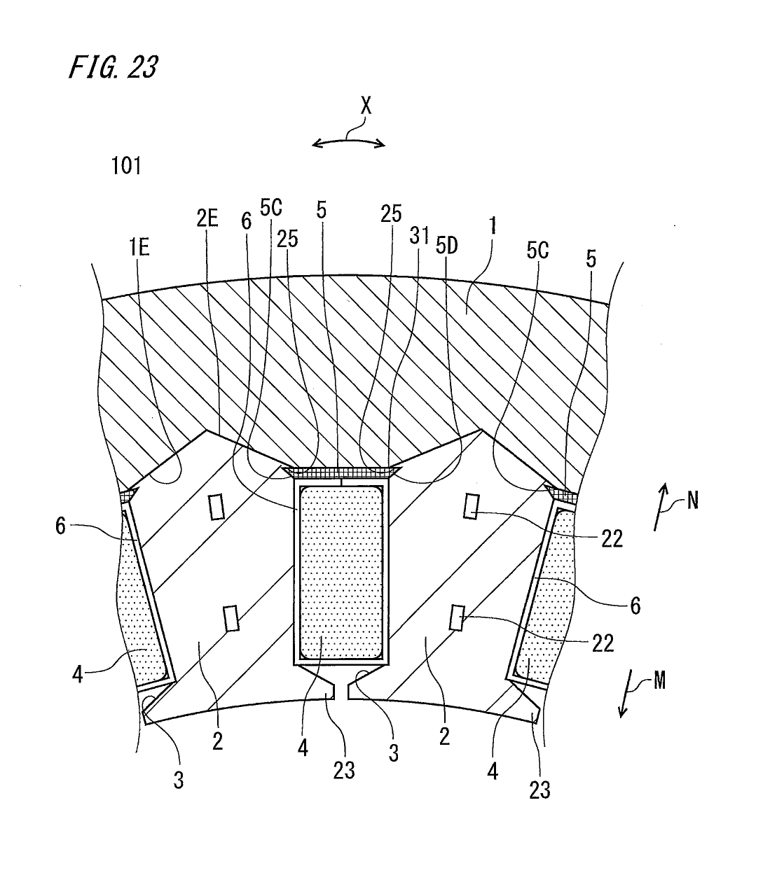

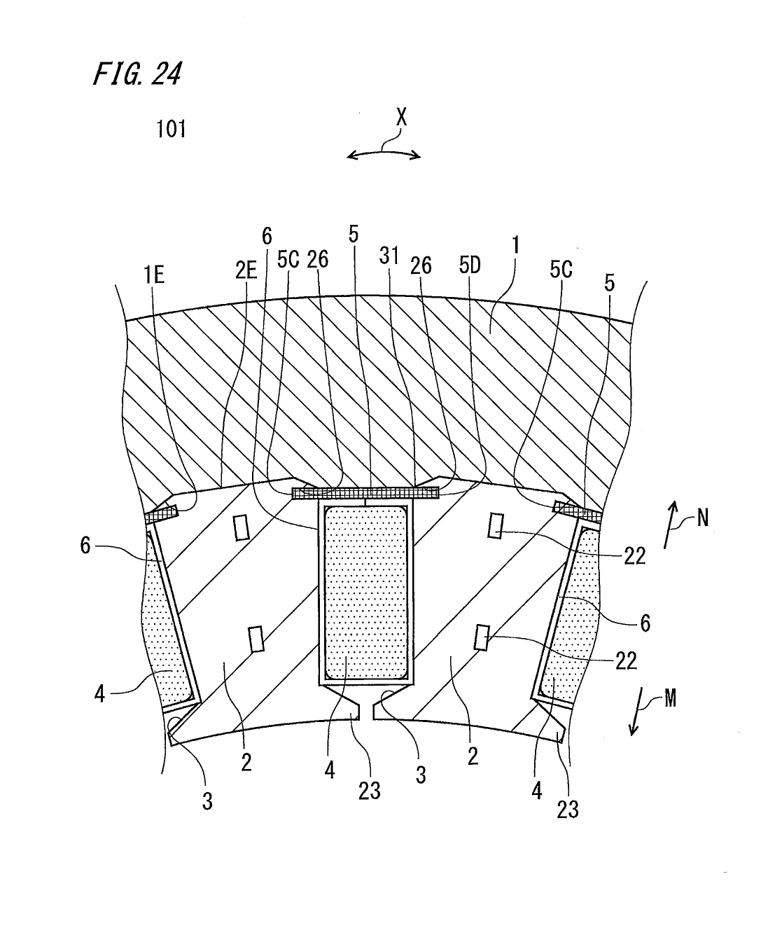

FIG. 23 and FIG. 24 are each a plan cross-sectional view showing the configuration of another armature according to Embodiment 2 of the present invention.

In FIG. 16, the same parts as those in Embodiment 1 described above are denoted by the same reference characters, and the description thereof is omitted. Embodiment 2 is different from Embodiment 1 described above in that each tooth portion 2 includes a groove 24 into which both sides 5C and 5D of the wedge 5 in the circumferential direction X are inserted and held. The wedge 5 is held such that both sides 5C and 5D thereof are inserted in the groove 24. Thus, the wedge 5 serves as a temporary holding mechanism that prevents the coil 4 from being ejected from the slot 3 until the back yoke portion 1 is fitted, allowing the back yoke portion 1 to be smoothly inserted.

Furthermore, the groove 24 is formed such that the cross-section thereof in the circumferential direction has a tapered shape. That is, both sides 5C and 5D of the wedge 5 are formed such that the cross-section thereof in the circumferential direction has a tapered shape so as to allow both sides 5C and 5D to be inserted into the groove 24. Thus, the wedge 5 is easily inserted into the groove 24, and manufacturing variations in the circumferential direction X can be absorbed by a gap on the central side M or the outer peripheral side N.

It is also conceivable that the insulating sheets 6 may be formed so as to overlap on the opening 31 sides of the slots 3 as shown in FIG. 16. In this case, the space for the coil 4 in each slot 3 is reduced, but the insulating properties improve.

Embodiment 1 has described the case in which the tooth portions 2, which are arranged annularly, are connected to each other at the connecting portions 23 in the circumferential direction X. Embodiment 2 describes the case in which the tooth portions 2, which are arranged annularly, are formed so as to include: layers in which the tooth portions 2 are connected to each other at the connecting portions 23 in the circumferential direction X (see FIG. 18); and layers in which the connecting portions 23 are not present and the tooth portions 2 are separated from each other in the circumferential direction X (see FIG. 16 and broken-line parts in FIG. 18). Even when there are the layers of the tooth portions 2 in which the tooth portions 2 are not connected to each other in the circumferential direction X, the annular shape of the tooth portions 2 is retained by the layers of the tooth portions 2 that include the connecting portions 23 because the tooth portions 2 are crimped at crimp portions 22 in the axial direction Y as in Embodiment 1 described above.

Furthermore, in Embodiment 2, since each wedge 5 is inserted into the groove 24, the wedge 5 serves as a stopper in the axial direction Y as with the crimp portions 22, and thus the layers of the tooth portions 2 that do not include the connecting portions 23 can be inhibited from projecting toward the back yoke portion 1. Thus, the armature 101 having higher quality can be configured. The purpose of forming the plurality of tooth portions 2 so as to include the layers including the connecting portions 23 and the layers not including the connecting portions 23, that is, partially connecting the plurality of tooth portions 2 at the connecting portions 23, as described above, is to reduce the leakage of magnetic flux to obtain a high-power rotating electrical machine.

In FIG. 17, the plurality of tooth portions 2 include a plurality of stacked magnetic steel plates 21, and the magnetic steel plates 21 are crimped at the crimp portions 22 in the axial direction Y as in Embodiment 1 described above. In FIG. 19, the back yoke portion 1 includes a plurality of stacked magnetic steel plates 11, and magnetic steel plates 11 are fixed in the axial direction T by crimping crimp portions 12 as in Embodiment 1 described above. The inner peripheral surface 1E of the back yoke portion 1 is formed so that the protruding surfaces 2E of the tooth portions 2 described above are fitted to the inner peripheral surface 1E.

The method fox manufacturing the armature 101 of the rotating electric machine 100 according to Embodiment 2 configured as described above is as follows. Similarly to Embodiment 1, each coil 4 is wound and housed in the slots 3 between the plurality of tooth portions 2, which are arranged annularly, with the insulating sheets 6 interposed therebetween, as shown in FIG. 20(A). Subsequently, the wedges 5 are disposed as shown in FIG. 20(B).

When both sides 5C and 5D of the wedge 5 are inserted into the groove 24 in the opening 31 of each slot 3, the wedge 5 is disposed on the opening 31 side of the slot 3, as shown in FIG. 21. At this time, since both sides 5C and 5D of the wedge 5 are inserted and held in the groove 24, the wedge 5 can be positioned even without the protrusions 51 described above in Embodiment 1.

Next, as shown in FIG. 22, the back yoke portion 1 is inserted from, the one ends 2A of the tooth portions 2 in the direction of the arrow P. Subsequently, as shown in FIG. 15 and FIG. 16, the protruding surface 2E of each tooth portion 2 is fitted to the inner peripheral surface 1E of the back yoke portion 1 in abutment therewith, to form the armature 101.

The groove 24 described above is not limited to such a configuration; various examples are conceivable, including, for example, a groove 25 shown in FIG. 23, which is tapered, in shape in a direction different from that in the above-described case, and a groove 26 shown in FIG. 24, which has a rectangular shape instead of the tapered shape. Both sides 5C and 5D of each wedge 5 are shaped so as to be able to be inserted into each of the grooves 25 and 26. Thus, when the groove 26 having a rectangular shape is formed, both sides of the wedge 5 have a simple shape, allowing a reduction in the production cost of the wedge 5.

It is also conceivable that each insulating sheet 6 may be formed so as to be fitted face-to-face on the opening 31 side of the slot 3 as shown in FIG. 23 and FIG. 24. This allows an increase in the space for the coil 4 in the slot 3, leading to an improvement in the ease of assembly or an increase in the number of conductor wires to provide a higher-power rotating electric machine.

According to Embodiment 2 configured as described above, not only the same advantageous effects as in Embodiment 1 described above can be achieved, but also the ease of assembly of each wedge is enhanced and the productivity improves because each tooth portion includes the groove that holds the wedge.

Furthermore, since the groove has a tapered shape, the tolerance of each wedge in the circumferential direction can be changed into tolerance in the radial direction inside the groove and thus absorbed, allowing for designing with excellent accuracy.

### Embodiment 3

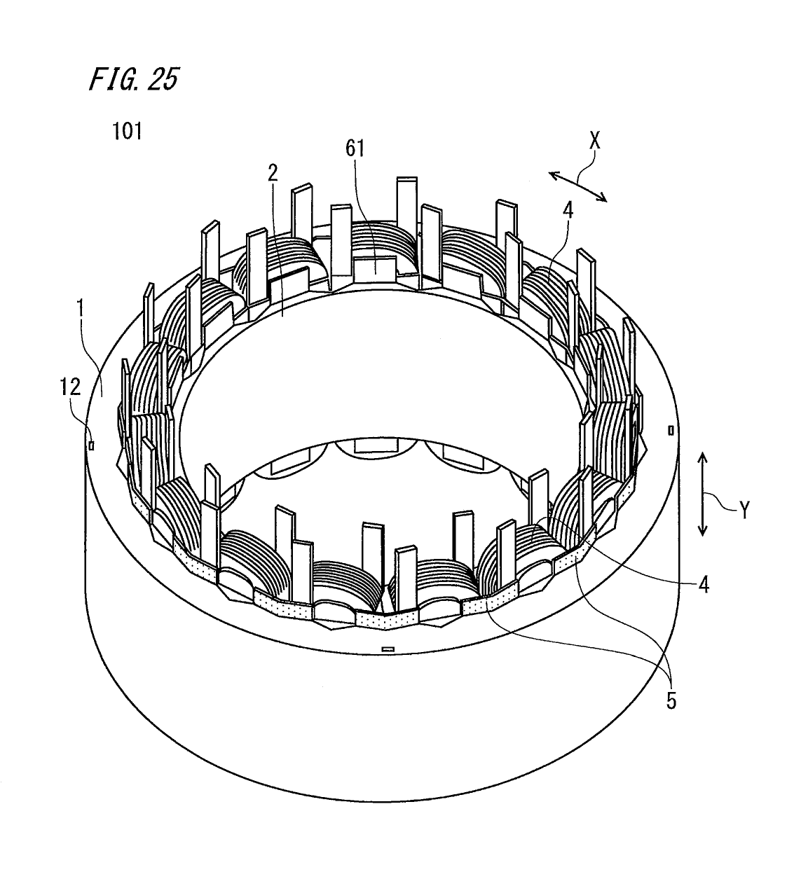

FIG. 25 is a perspective view showing the configuration of an armature according to Embodiment 3 of the present invention.

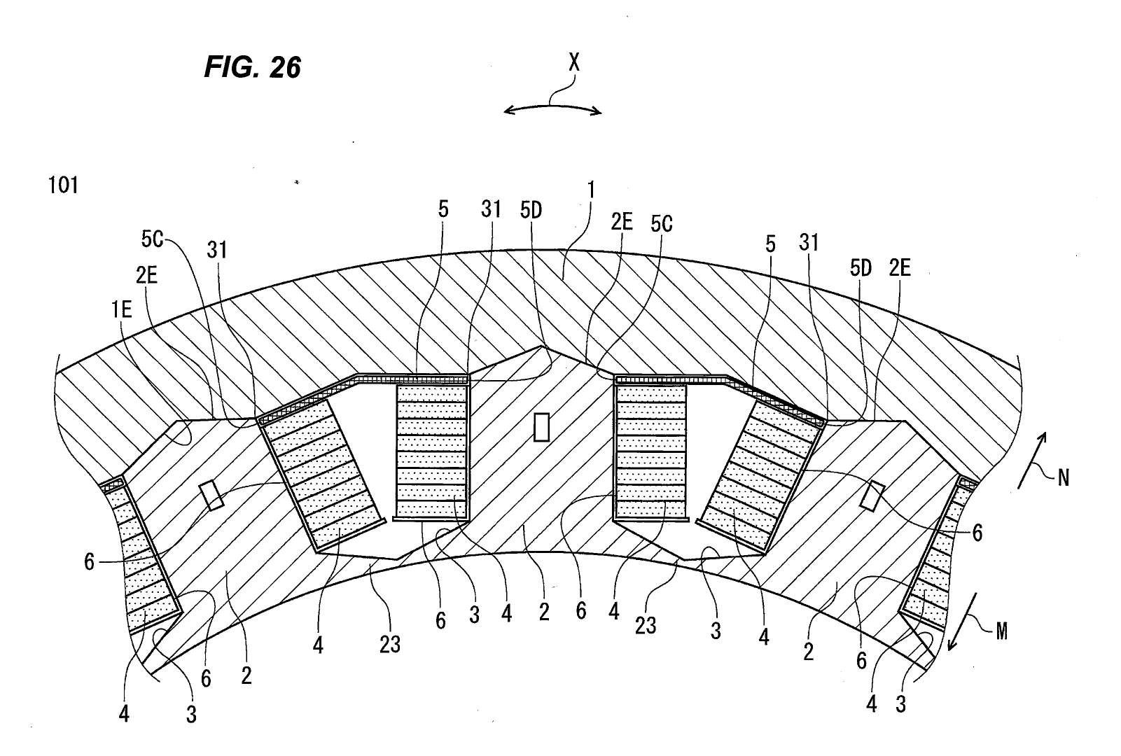

FIG. 26 is a partial plan cross-sectional view showing a cross-section taken on a plane through a part of the configuration of the armature shown in FIG. 25.

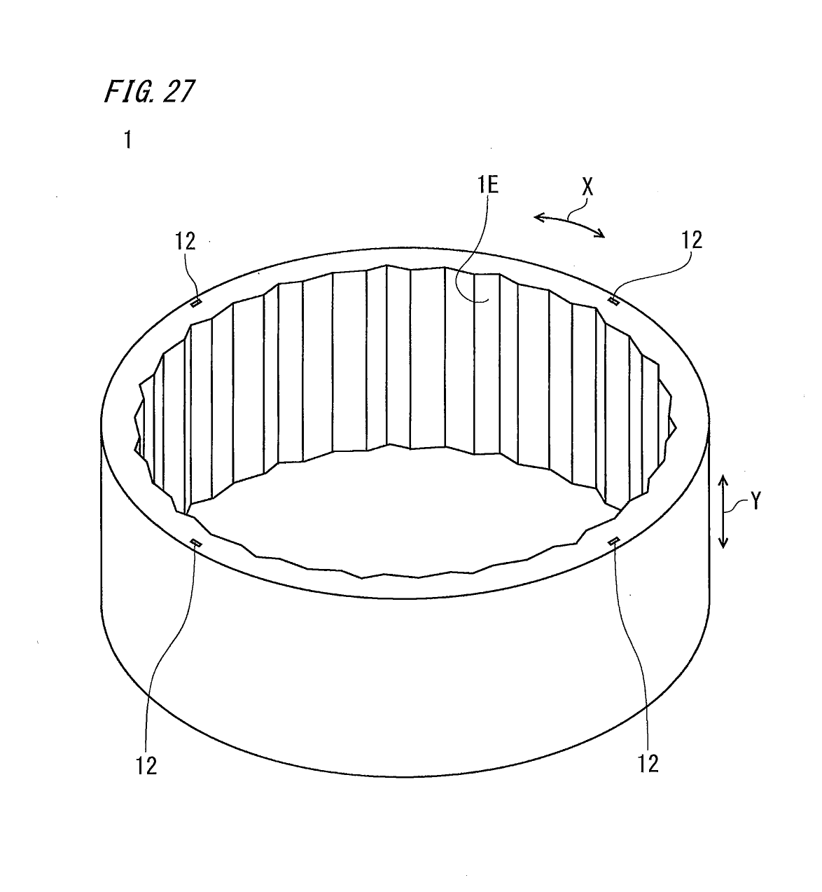

FIG. 27 is a perspective view showing the configuration of a back yoke portion of the armature shown in FIG. 25.

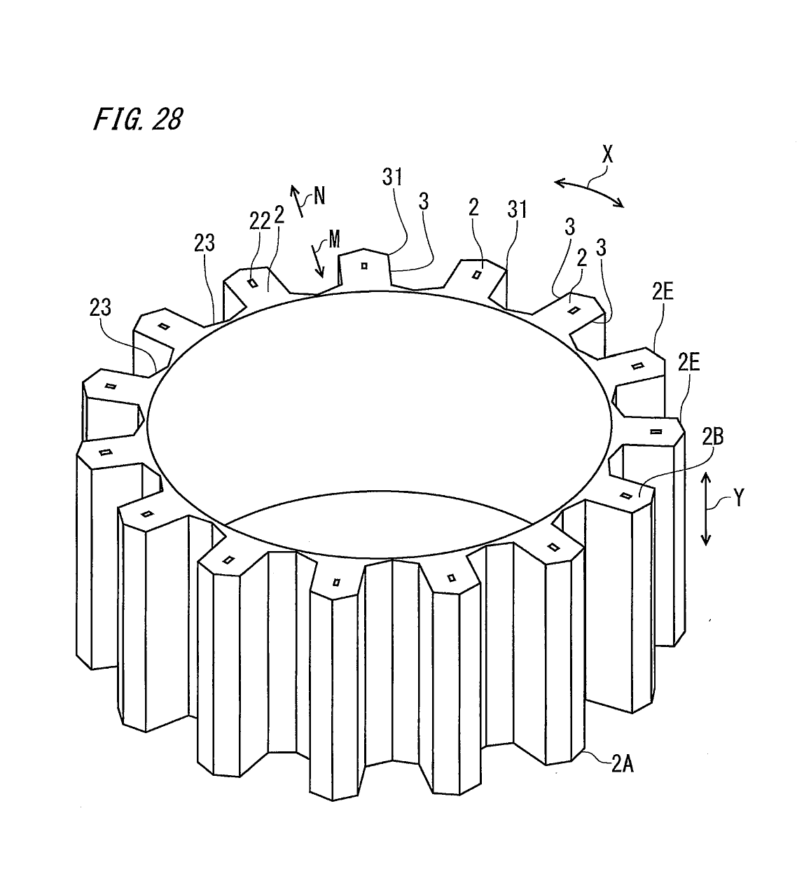

FIG. 28 is a perspective view showing the configuration of tooth portions of the armature shown in FIG. 25.

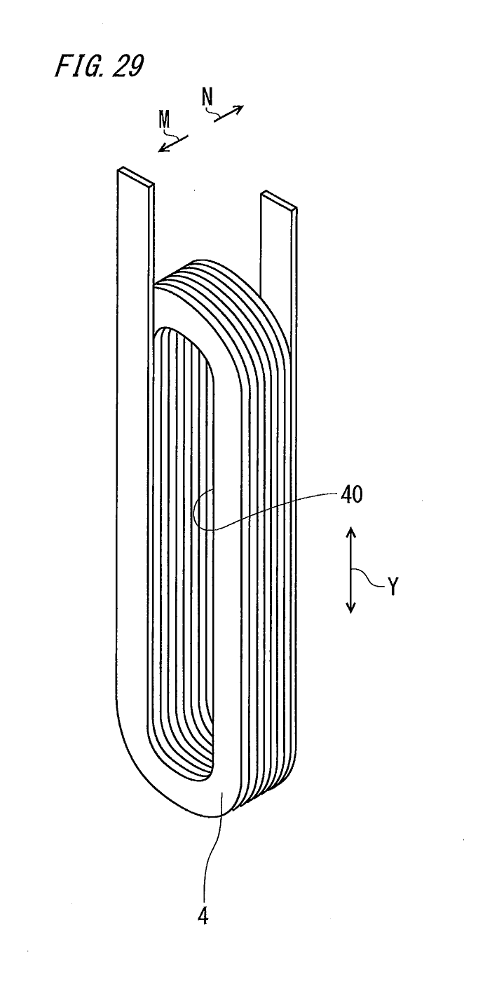

FIG. 29 is a perspective view showing the configuration of a coil of the armature shown in FIG. 25.

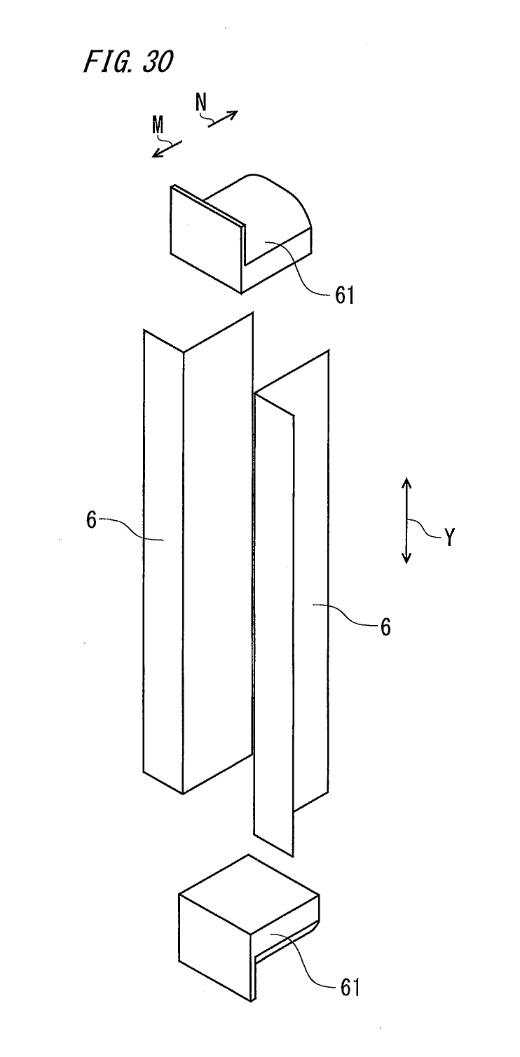

FIG. 30 is an exploded perspective view showing the configuration of insulating sheets and bobbins of the armature shown in FIG. 25.

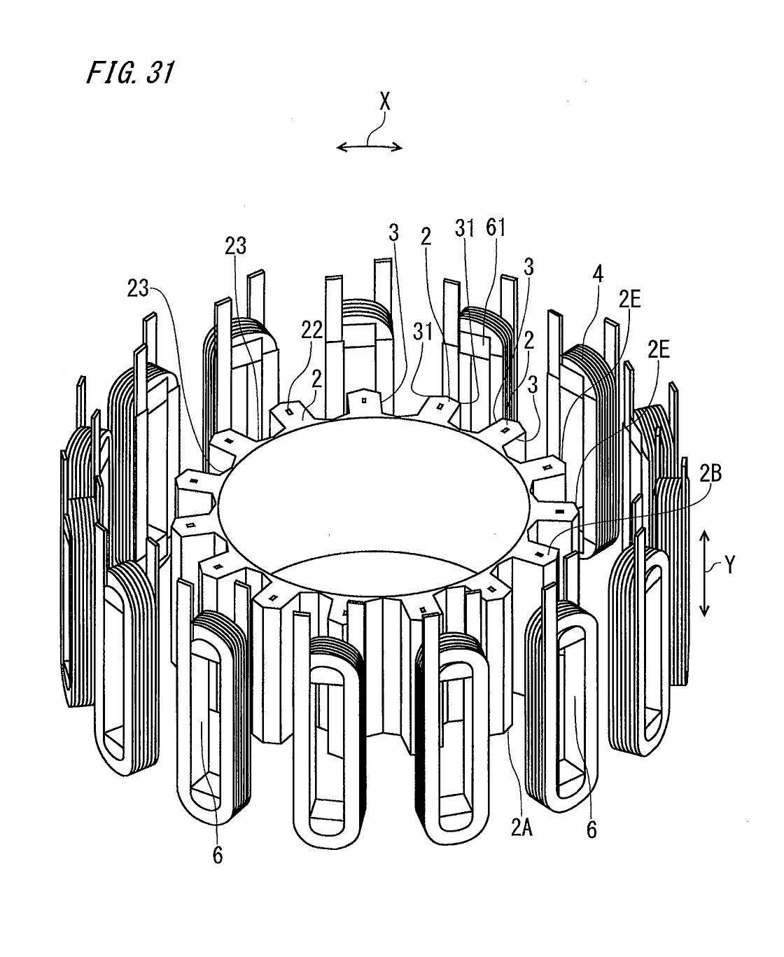

FIG. 31 to FIG. 33 are diagrams for describing a method for manufacturing the armature shown in FIG. 25.

FIG. 31 is a perspective view showing a state before coils are inserted to the tooth portions.

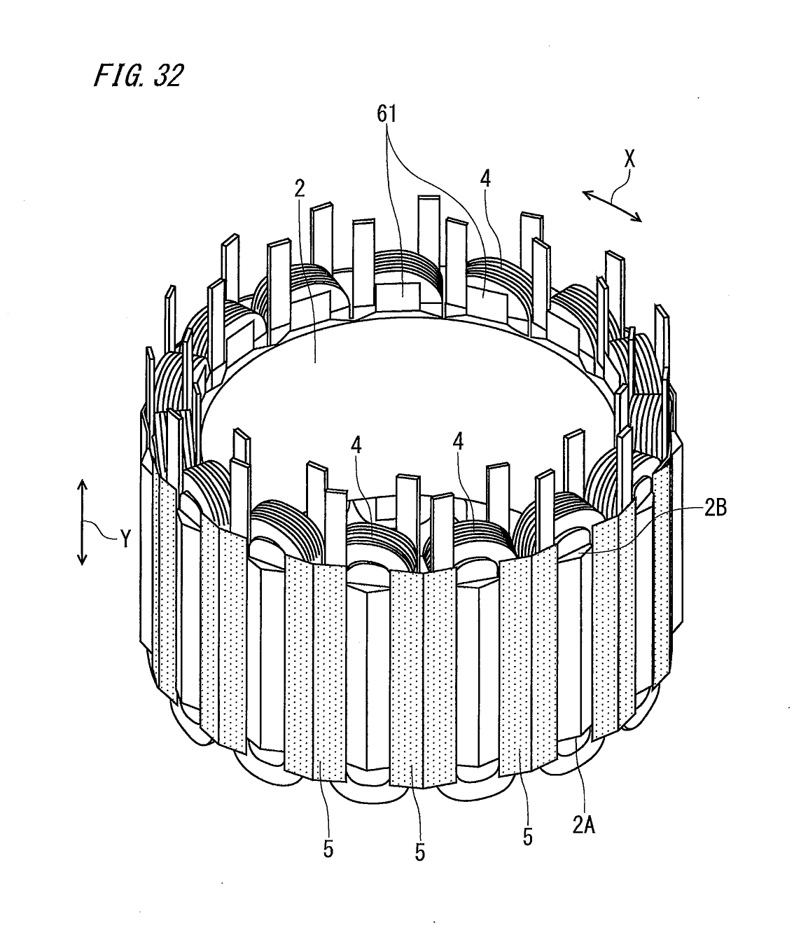

FIG. 32 is a perspective view showing a state after the wedges are inserted to the tooth portions.

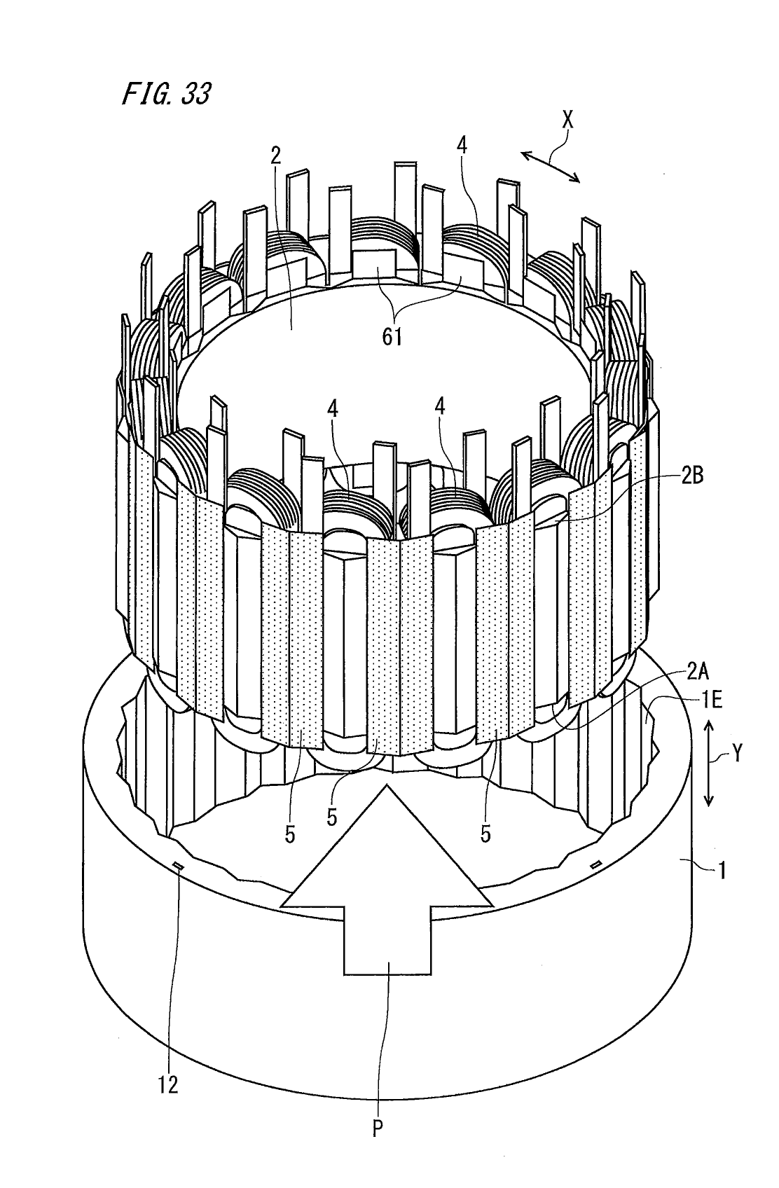

FIG. 33 is a perspective view showing a state before the back yoke portion is inserted to the tooth portions.

In the drawings, the same parts as those in each of the embodiments described above are denoted by the same reference characters, and the description thereof is omitted. Each of the embodiments has described the example of a distributed winding type in which the coils 4 are provided across the plurality of tooth portions 2; Embodiment 3 describes an example of a concentrated winding type in which a single coil 4 is provided exclusively on one tooth portion 2.

As shown in FIG. 29, the coil 4 is formed by winding a rectangular wire edgewise. When a magnet is used for the rotor 105 with such a coil 4, it is necessary to reduce eddy current that is generated in the rectangular wire forming the coil 4. For this reason, a structure is required in which the tooth portion 2 and the back yoke portion 1 are separate, as described in Embodiment 3, so that a collar portion for reducing eddy current can be easily formed on the protruding surface 2E of each tooth portion 2 on the outer peripheral side N.

As shown in FIG. 30, bobbins 61 are provided on the top and the bottom of the insulating sheets 6 in the axial direction Y, respectively. Thus, the bobbins 61 are provided on the one end 2A and the opposite end 2B of the tooth portion 2 in the axial direction Y, respectively. The coil 4 is provided on the one end 2A and the opposite end 2B of the tooth portion 2 in the axial direction Y with the bobbins 61 interposed therebetween. Consequently, the bobbins 61 inhibit the coil 4 from being displaced in the axial direction Y on the tooth portion 2, that is, prevent the coil 4 from becoming uneven on the one end 2A and the opposite end 2B of the tooth portion 2 in the axial direction Y.

Next, a description, will be given of a method for manufacturing the armature 101 of the rotating electric machine 100 according to Embodiment 3 configured as described above. First, the insulating sheets 6 as shown in FIG. 30 are placed at the left and right sides in a winding hole 40 of each coil 4 wound as shown in FIG. 29. The bobbins 61 are then placed at the top and the bottom of the winding hole 40 of each coil 4 in the axial direction Y. Next, the coils 4 are placed in the slots 3 between the plurality of tooth portions 2, which are formed as shown in FIG. 28 and arranged annularly. Specifically, as shown in FIG. 31, each coil 4 provided with the insulating sheets 6 and the bobbins 61 is placed on the tooth portion 2 from outside in the radial direction so that the tooth portion 2 is inserted into the winding hole 40 of the coil 4. As shown in FIG. 32, each coil 4 provided with the insulating sheets 6 and the bobbins 61 is then placed in the slot 3.

Next, when the wedge 5 is inserted to the opening 31 side of each slot 3, the wedge 5 is disposed on the opening 31 side of the slot 3, as shown in FIG. 32. Next, as shown in FIG. 33, the back yoke portion 1 is inserted from the one ends 2A of the tooth portions 2 in the direction of the arrow P. Subsequently, as shown in FIG. 25 and FIG. 26, the protruding surface 2E of each tooth portion 2 is fitted to the inner peripheral surface 1E of the back yoke portion 1 in abutment therewith, to form the armature 101.

At this time, similarly to each of the embodiments described above, the wedges 5 are located between the coils 4 and the back yoke portion 1, and therefore damage of the coils 4 due to the back yoke portion 1 is prevented. Furthermore, the wedges 5 prevent the insulating sheets 6 from, being exposed in the openings 31 of the slots 3, and therefore damage of the inner peripheral surface 1E of the back yoke portion 1 due to the insulating sheets 6 is prevented.

According to Embodiment 3 configured as described above, the same advantageous effects as in each of the embodiments described above can be achieved even with the concentrated-winding coils.

It is noted that, within the scope of the present invention, the above embodiments may be freely combined with each other, or each of the above embodiments may be modified or simplified as appropriate.

1. An armature comprising:
a back yoke portion formed in an annular shape;
a plurality of tooth portions arranged annularly on an inner periphery of the back yoke portion and forming a plurality of slots that are spaced apart in a circumferential direction and open on an outer peripheral side, the plurality of tooth portions being fitted to an inner peripheral surface of the back yoke portion;
a coil housed in the plurality of slots; and
a wedge disposed between the coil and the back yoke portion, on an opening side of each of the plurality of slots.

2. The armature according to claim 1, wherein
an insulating sheet is formed between the coil and each tooth portion, and
a thickness of the wedge is set to be greater than a thickness of the insulating sheet.

3. The armature according to claim 2, wherein the insulating sheet is formed between the coil and the wedge.

4. The armature according to claim 1, wherein each of the back yoke portion and the tooth portions is formed by stacking a plurality of steel plates.

5. The armature according to claim 1, wherein a length of the wedge in an axial direction is set to be greater than a length of each tooth portion in the axial direction.

6. The armature according to claim 1, wherein
a protrusion protruding in the circumferential direction is formed on one end of the wedge in an axial direction, and
the protrusion abuts one end of each tooth portion in the axial direction.

7. The armature according to claim 1, wherein a connecting portion connecting each wedge is formed on one end of each wedge in an axial direction.

8. The armature according to claim 1, wherein connecting portions connecting each wedge are formed on one end and an opposite end of each wedge in an axial direction, respectively.

9. The armature according to claim 1, wherein the wedge is formed of an insulating member or a magnetic member.

10. The armature according to claim 1, wherein a groove, holding both sides of the wedge in the circumferential direction is formed on each tooth portion.

11. The armature according to claim 10, wherein the groove, of each tooth portion has a tapered shape.

12. A rotating electric machine comprising:
an armature and a rotor disposed in the annular shape of the armature,
wherein the armature comprises:
a back yoke portion formed in an annular shape,
a plurality of tooth portions arranged annularly on an inner periphery of the back yoke portion and forming a plurality of slots that are spaced apart in a circumferential direction and open on an outer peripheral side, the plurality of tooth portions being fitted to an inner peripheral surface of the back yoke portion;
a coil housed in the plurality of slots; and
a wedge disposed between the coil and the back yoke portion, on an opening side of each of the plurality of slots.

13. The armature according to claim 2, wherein each of the back yoke portion and the tooth portions is formed by stacking a plurality of steel plates.

14. The armature according to claim 2, wherein a length of the wedge in an axial direction is set to be greater than a length of each tooth portion in the axial direction.

15. The armature according to claim 2, wherein
a protrusion protruding in the circumferential direction is formed on one end of the wedge in an axial direction, and
the protrusion abuts one end of each tooth portion in the axial direction.

16. The armature according to claim 2, wherein a connecting portion connecting each wedge is formed on one end of each wedge in an axial direction.

17. The armature according to claim 2, wherein connecting portions connecting each wedge are formed on one end and an opposite end of each wedge in an axial direction, respectively.

18. The armature according to claim 2, wherein the wedge is formed of an insulating member or a magnetic member.

19. The armature according to claim 2, wherein a groove, holding both sides of the wedge in the circumferential direction is formed on each tooth portion.
